(19) United States
(12) Patent Application Publication
(10) Pub. No.: US 2004/0002365 A1
(43) Pub. Date: Jan. 1, 2004

(54) Information transmission method and system

(75) Inventors: Michihiro Ota, Sakado-shi (JP); Hiroaki Yoshida, Tsurugashima-shi (JP); Hiroaki Shinada, Tsurugashima-shi (JP); Kumiko Hisai, Sakado-shi (JP); Hiroki Hoshino, Kawagoe-shi (JP)

Correspondence Address: WELSH & KATZ, LTD, 120 S RIVERSIDE PLAZA, 22ND FLOOR, CHICAGO, IL, 60606, US

(73) Assignee: Kabushiki Kaisha Nippon Conlux, Tokyo (JP)

(21) Appl. No.: 10/458,118

(22) Filed: Jun. 10, 2003

(30) Foreign Application Priority Data
Jun. 27, 2002 (JP) 2002-188216

(51) Int. Cl. H04Q 7/20; H04M 1/00

(52) U.S. Cl. 455/566; 455/466

(57) ABSTRACT

An information transmission method and a system capable of transmitting information without requiring a troublesome operation and at a low cost is provided. A portable communication terminal such as a cellular phone, a PHS or the like capable of making a telephone call and performing communications over a telephone line changes an image to be displayed on a display portion with time to transmit information to an information-receiving device. The information-receiving device receives a change in display of the image on the portable communication terminal by a receiver portion and recognizes the information from the received change in display (e.g., a display interval, etc.).

### CROSS-REFERENCE TO RELATED APPLICATIONS

This application is based upon and claims the benefit of priority from the prior Japanese Patent Application No. 2002-188216 filed on Jun. 27, 2002; the entire contents of which are incorporated herein by reference.

### BACKGROUND OF THE INVENTION

1. Field of the Invention

The present invention relates to an information transmission method and a system, and more particularly to an information transmission method and a system capable of transmitting desired information to other device by using a display of a portable communication terminal or the like.

2. Description of the Related Art

It has been proposed to transmit information from a portable communication terminal such as a cellular phone to any devices other than the portable communication terminal by means of infrared communication, image recognition by reading a bar code or manual input through a keyboard.

However, transmitting information by the infrared communication had problems of a high cost and upsizing because the portable communication terminal is required to have communication means for the infrared communication and an information-receiving device which receives information is also required to have such communication means.

The use of image recognition to read a bar code or the like also had problems of a high cost and upsizing of a device for receiving information.

Further, the manual input through a keyboard also had problems of troublesome input of necessary information, input in error or the like.

### SUMMARY OF THE INVENTION

The object of the present invention is to solve the above-mentioned problems and provide an information transmission method and a system capable of transmitting desired information without requiring complicated operations and at a low cost.

To achieve the above-mentioned object, an aspect of the invention provides an information transmission method, comprising: alternately displaying on a display an image having a first color and an image having a second color at prescribed intervals in accordance with information to be sent; detecting the display intervals between the image having the first color and the image having the second color displayed on the display and receiving the information according to the detected display intervals by other device; and transmitting the information from the device having the display to the other device.

Another aspect of the invention provides an information transmission system, comprising: a first device including a display and display control means for alternately displaying an image having a first color and an image having a second color on the display at prescribed intervals according to information to be sent; and a second device including receiving means for detecting the display intervals between the image having the first color and the image having the second color displayed on the display and receiving the information according to the detected display intervals; wherein: desired information is sent to the second device by using the display of the first device.

According to the present invention, it is possible to transmit information without involving a troublesome operation and at a low cost.

### BRIEF DESCRIPTION OF THE DRAWINGS

FIG. 1 is a diagram showing an example of a structure of an information transmission system according to the present invention;

FIG. 2 is a block diagram showing an example of a general structure of a portable communication terminal 1;

FIG. 3 is a diagram showing an example of an appearance of the portable communication terminal 1;

FIG. 4A is a diagram showing an example of a display portion 2 displaying an image 3 when information is transmitted by a change in display of the image 3 displayed on the display portion 2;

FIG. 4B is a diagram showing an example of the display portion 2 not displaying the image 3 when information is transmitted by a change in display of the image 3 displayed on the display portion 2;

FIG. 5 is a block diagram showing an example of a general structure of an information-receiving device 4;

FIG. 6A is a diagram showing an example in that the image 3 displayed on the display portion 2 of the portable communication terminal 1 has two colors, and one of the colors of the image 3 is the same color as the background color of the display portion 2;

FIG. 6B is a diagram showing a first example in that the image 3 displayed on the display portion 2 of the portable communication terminal 1 has multiple colors (n colors);

FIG. 6C is a diagram showing a second example in that the image 3 displayed on the display portion 2 of the portable communication terminal 1 has multiple colors (n colors); and

FIG. 7 is a flow chart showing a procedure of processing for information transmission conducted between the portable communication terminal 1 and the information-receiving device 4.

### DESCRIPTION OF THE PREFERRED EMBODIMENTS

Embodiments of the information transmission method and system according to the present invention will be described in detail with reference to the accompanying drawings.

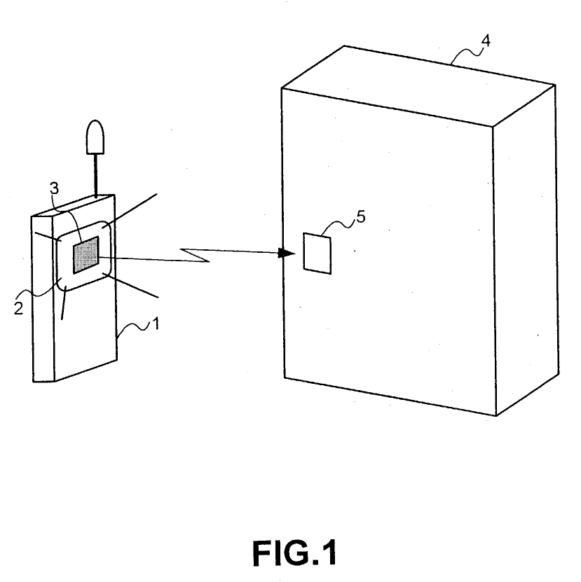

FIG. 1 is a diagram showing an example of a structure of the information transmission system according to the present invention.

As shown in FIG. 1, the portable communication terminal 1 such as a cellular phone or a PHS capable of making a telephone call and performing communications over a telephone line changes the image 3 displayed on the display portion 2 with time to transmit information to the information-receiving device 4. The information-receiving device 4 receives a change in display of the image displayed on the portable communication terminal 1 by a receiver portion 5 and recognizes information from the received display change (e.g., display intervals).

For example, where the information-receiving terminal 4 is an automatic vending machine and a user buys an article from the automatic vending machine, he or she transmits user information, buying article information, etc. to the automatic vending machine by a display change of the image 3 displayed on the display portion 2 of the portable communication terminal 1. The automatic vending machine receives the display change of the image 3 displayed on the portable communication terminal 1 by the receiver portion 5 and recognizes the user information and the buying article information from the received display change, sells the article, and adds a charge for the sold article to the usage charge of the user's portable receiving terminal 1.

Where the information-receiving device 4 is a door lock unit, a user who releases the door lock transmits user information and door lock releasing information to the door lock unit by using a display change of the image 3 displayed on the display portion 2 of the portable communication terminal 1. The door lock unit receives the display change of the image 3 displayed on the portable communication terminal 1 by the receiver portion 5, recognizes the user information and door lock releasing information and the like from the received display change, releases the door lock and records who has released the door lock on door opening/closing management information.

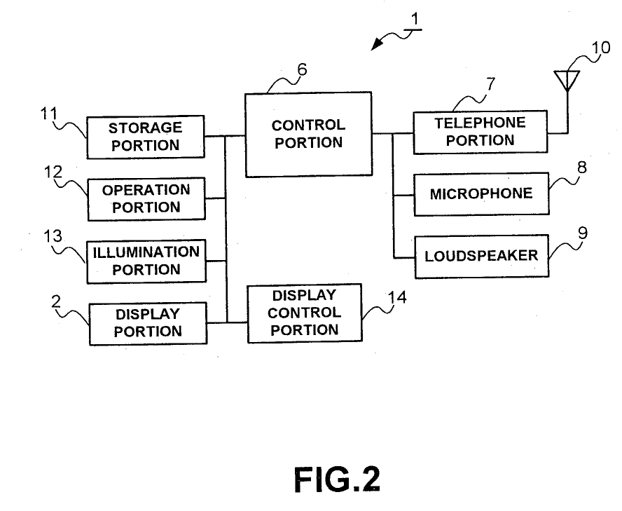

FIG. 2 is a block diagram showing an example of a general structure of the portable communication terminal 1.

As shown in FIG. 2, the portable communication terminal 1 comprises a control portion 6, a telephone portion 7, a microphone 8, a loudspeaker 9, an antenna 10, a storage portion 11, an operation portion 12, an illumination portion 13, the display portion 2, and a display control portion 14.

The control portion 6 controls the entire portable communication terminal 1 and executes a program or the like stored in the storage portion 11.

The telephone portion 7 is used to make a telephone call and perform communications over a telephone line (wireless). Here, during the telephone conversation, voices input through the microphone 8 are undergone voice processing by the telephone portion 7, superposed on a radio wave having a prescribed frequency and sent from the antenna 10 to an unshown base station. Meanwhile, a radio wave to be received from the base station is input to the telephone portion 7 through the antenna 10, and the telephone portion 7 extracts a prescribed signal from the input radio wave, demodulates the extracted signal to vocalize and outputs from the loudspeaker 9.

The storage portion 11 stores a control program for controlling the portable communication terminal 1, a program (application software) for execution of a display change of the image 3 on the display portion 2 to transmit information, and the like.

The operation portion 12 accepts instructions to and setting of the individual portions of the portable communication terminal 1, start and end of communications, setting of destination and the like made by the user.

The illumination portion 13 turns on or off a backlight for illumination of the display surface of the display portion 2 and a backlight for illumination of a plurality of operation keys (not shown) of the operation portion 12.

The display portion 2 is configured of a liquid crystal display or the like and shows the user a variety of information, images or the like input through the operation portion 12.

The display control portion 14 reads the program or the like stored in the storage portion 11 and controls to display the image 3 on the display portion 2, to change the displayed image 3, or the like.

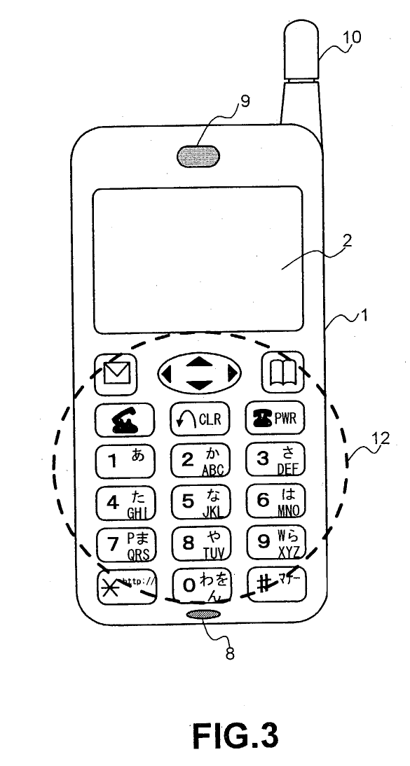

FIG. 3 is a diagram showing an example of the appearance of the portable communication terminal 1.

As shown in FIG. 3, the portable communication terminal 1 has on its housing the loudspeaker 9, the microphone 8, the operation portion 12 (operation keys), the display portion 2 (liquid crystal display) and the antenna 10. The user operates the operation portion 12 to change the image 3 displayed on the display portion 2 with time.

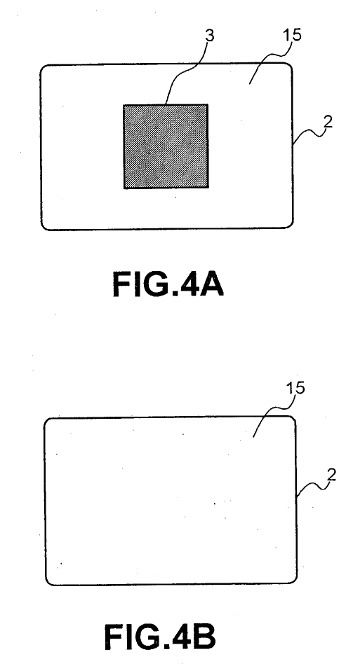

FIG. 4A shows an example of the display portion 2 displaying the image 3 when information is sent by a display change of the image 3 displayed on the display portion 2, and FIG. 4B shows an example of the display portion 2 not displaying the image 3 when information is sent by a display change of the image 3 displayed on the display portion 2. As shown in FIG. 4A, the image 3 displayed on the display portion 2 is white or black, a background 15 on the display portion 2 has a white color, and the color of the background 15 remains unchanged. And, the display of the image 3 is changed to transmit information to the information-receiving device 4.

For example, it is assumed that an image display in black is “1” and an image display in white is “0” in a prescribed period of time, and the image 3 is displayed by alternately displaying the black image and the white image at prescribed intervals to generate a digital signal. The generated digital signal is used to transmit information to the information-receiving device 4.

In the embodiment described above, the display color of the image 3 is white or black and the background 15 of the display portion 2 is white, but it can also be configured to have the background 15 of the display portion 2 in black and also the display color of the image 3 in color. When the image 3 is displayed in color, an amount of information to be sent can be increased.

The image 3 shown in FIG. 4A and FIG. 4B has a square shape, but the image 3 may have a rectangular, polygonal or circular shape. And, the image 3 is not limited to have a particular size and can have a size covering, for example, the entire display portion 2.

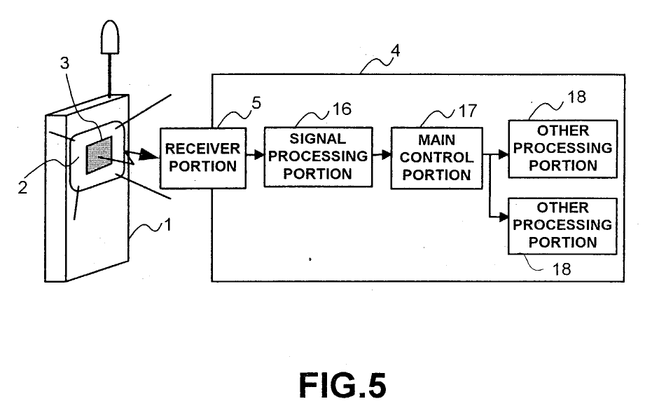

FIG. 5 is a block diagram showing an example of a general structure of the information-receiving device 4.

As shown in FIG. 5, the information-receiving device 4 comprises a receiver portion 5, a signal processing portion 16, a main control portion 17 and other processing portions 18.

Here, a display change of the image 3 displayed on the display portion 2 of the portable communication terminal 1 is received by the receiver portion 5, and the received display change is sent to the signal processing portion 16. The signal processing portion 16 recognizes information according to the received display change and transmits the recognized information to the main control portion 17. And, the main control portion 17 instructs control and operation based on the received information to the other processing portions 18.

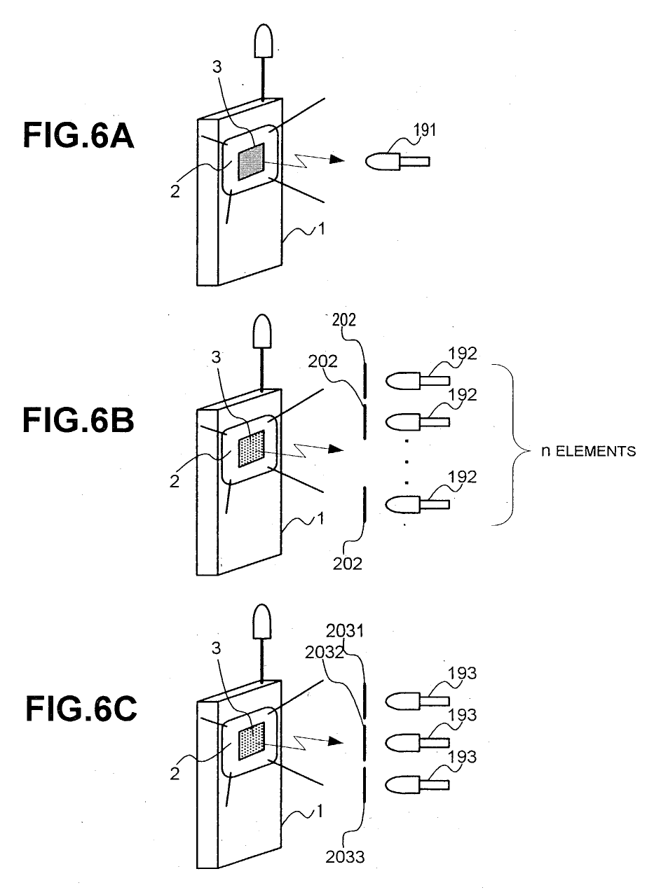

FIG. 6A shows an example where the image 3 displayed on the display portion 2 of the portable communication terminal 1 has two colors, and one of the two colors of the image 3 is the same to the color of the background of the display portion 2. As shown in FIG. 6A, the receiver portion 5 comprises a single light receiving element 191, which receives a display change of the image 3 on the display portion 2. Even when the image 3 is displayed in two colors, an amount of information to be sent can be increased by adding contrast (gradation) to the display colors of the image 3 when the image 3 is displayed.

FIG. 6B is a first example where the image 3 displayed on the display portion 2 of the portable communication terminal 1 has plural colors (n colors). As shown in FIG. 6B, the receiver portion 5 comprises n numbers of light receiving elements 192 and n numbers of optical filters 202 having different transmission colors. The optical filters 202 are disposed in front of the light receiving elements 192.

For example, when the image 3 has three display colors of red, blue and yellow, the optical filter 202 allowing the passage of red, the optical filter 202 allowing the passage of blue and the optical filter 202 allowing the passage of yellow are disposed. When the image 3 displayed is red, the light receiving element 192 disposed behind the optical filter 202 which allows the passage of red receives the image 3, when the image 3 displayed is blue, the light receiving element 192 disposed behind the optical filter 202 which allows the passage of blue receives the image 3, and when the image 3 displayed is yellow, the light receiving element 192 disposed behind the optical filter 202 which allows the passage of yellow receives the image 3.

Therefore, when the display colors of the image 3 are changed to display the image 3, an amount of information to be sent can be increased.

FIG. 6C is a second example where the image 3 which is displayed on the display portion 2 of the portable communication terminal 1 has multiple colors (n colors). As shown in FIG. 6C, the receiver portion 5 comprises three light receiving elements 193, an optical filter 2031 allowing the passage of R component (red) of the primary colors of light, an optical filter 2032 allowing the passage of G component (green) of the primary colors of light, and an optical filter 2033 allowing the passage of B component (blue) of the primary colors of light. The installation relationship between the light receiving element 193 and the respective optical filters (2031 to 2033) is the same as in FIG. 6B.

For example, when the image 3 is displayed on the display portion 2, the respective light receiving elements 193 receive the R, G and B components having passed through the respective optical filters (2031 to 2033) and determine the display colors of the image 3 according to an amount of light of the received R, G and B components.

Therefore, an increase in the amount of information to be sent by changing the display colors of the image 3 at a time of displaying the image 3 is made by the same way as the configuration shown in FIG. 6B, and even when the image 3 displayed on the display portion 2 has multiple colors, the information-receiving device 4 can be made more compact by using the three optical elements 193 for judgment of the display colors of the image 3.

In the configuration shown in FIG. 6B or FIG. 6C, a light receiving element not having an optical filter in front of it may be additionally disposed to determine the threshold of binarization when an optical signal is converted into a digital signal according to the amount of light received by the newly disposed light receiving element.

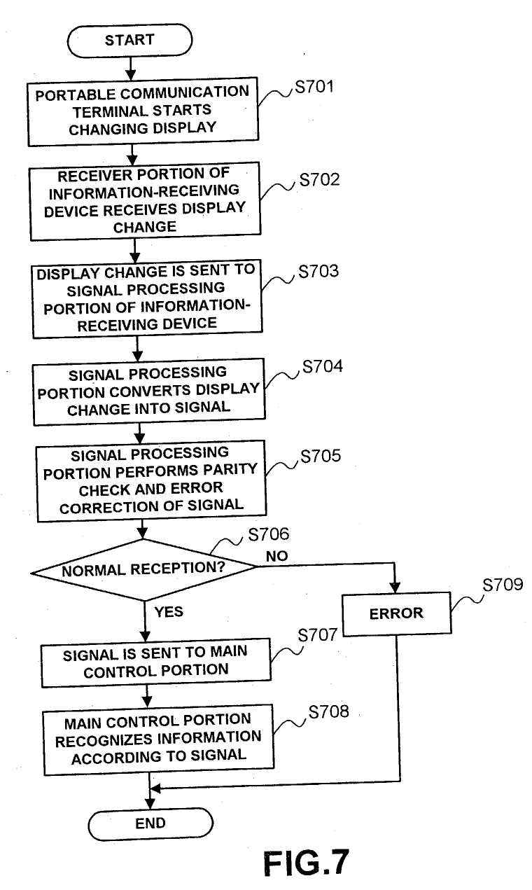

Then, a processing procedure for information transmission conducted by the portable communication terminal 1 and the information-receiving device 4 will be described with reference to the flow chart shown in FIG. 7.

When the user directs the display portion of a portable communication terminal to the receiver portion of an information-receiving device and operates the operation portion of the portable communication terminal, the image on the display portion is started to change its display (step S701), and the receiver portion of the information-receiving device receives the change in the display portion of the portable communication terminal (step S702) and transmits the received display change to the signal processing portion (step S703). The signal processing portion converts the received display change into a signal (step S704), performs a parity check and error correction of the converted signal (step S705), and when the reception is normal (YES in step S706), transmits the signal to the main control portion (step S707). The main control portion recognizes the information received from the portable communication terminal according to the received signal (step S708) and the processing procedure is terminated.

When the reception in step S706 is not normal (NO in step S706), the user is informed of an error or the like (step S709) and the processing procedure is terminated.

What is claimed is:

1. An information transmission method, comprising:
alternately displaying on a display an image having a first color and an image having a second color at prescribed intervals in accordance with information to be sent;
detecting the display intervals between the image having the first color and the image having the second color displayed on the display and receiving the information according to the detected display intervals by other device; and
transmitting the information from the device having the display to the other device.

2. The information transmission method according to claim 1, wherein the first color and the second color are white or black.

3. The information transmission method according to claim 1, wherein:
the first color and the second color are colors, and
the other device detects the display intervals between the image having the first color and the image having the second color and their colors displayed on the display, and receives the information according to the detected display intervals and the colors.

4. The information transmission method according to claim 1, wherein the image having the first color and the image having the second color are displayed on a background color having a particular color.

5. An information transmission system, comprising:
a first device including a display and display control means for alternately displaying an image having a first color and an image having a second color on the display at prescribed intervals according to information to be sent; and
a second device including receiving means for detecting the display intervals between the image having the first color and the image having the second color displayed on the display and receiving the information according to the detected display intervals; wherein:
desired information is sent to the second device by using the display of the first device.

6. The information transmission system according to claim 5, wherein the first color and the second color displayed on the display by the display control means are white or black.

7. The information transmission system according to claim 5, wherein:
the first color and the second color displayed on the display by the display control means are colors, and
the receiving means detects the display intervals between the image having the first color and the image having the second color and the colors displayed on the display and receives the information according to the detected display intervals and colors.

8. The information transmission system according to claim 5, wherein the display control means displays the images having the first color and the second color on a background color having a particular color.
